(19) United States
(12) Patent Application Publication
(10) Pub. No.: US 2025/0156956 A1
(43) Pub. Date: May 15, 2025

(54) METHOD AND SYSTEM FOR COOPERATIVE LIFE INSURANCE WITH VARIABLE PAYOUT

(71) Applicant: Takadao Holdings Pte Ltd, Singapore (SG)

(72) Inventors: Sha Rene Lee, Riyadh (SA); Morrad Irsane, Riyadh (SA); Sander Hansen, Southbank (AU); Robert Jan Smit, Bem Viver (PT)

(21) Appl. No.: 18/749,381

(22) Filed: Jun. 20, 2024

Related U.S. Application Data
(60) Provisional application No. 63/597,689, filed on Nov. 9, 2023.
(60) Provisional application No. 63/547,997, filed on Nov. 10, 2023.

(51) Int. Cl. G06Q 40/08; G06Q 20/08

(52) U.S. Cl. CPC G06Q 40/08; G06Q 20/085

(57) ABSTRACT

A cooperative life insurance fund with a variable payout is described. Insurance payout is determined by multiplying the policyholder's contribution with a base benefit multiplier, determined based on the policyholder's personal profile, and a benefit adjustment factor that depends on the overall financial performance of the fund at payout time. The benefit adjustment factor is computed via either (i) the current claims reserve size compared to target claims reserve size with future cash flows taken into account, (ii) the difference between actual claims at payout time and projected claims at the time of policy initiation, or (iii) using the fund's excess loss ratio over the target loss ratio. The fund is backed by at least one fund operator that invests the fund's pool and returns a portion of the profit. The fund's surplus is computed and redistributed to all policyholders using a multiplier proportional to each policyholder's total contributions.

### CROSS-REFERENCE TO RELATED APPLICATIONS

This application which claims benefit of U.S. Provisional Application No. 63/597,689, filed Nov. 9, 2023, and U.S. Provisional Application No. 63/547,997, filed Nov. 10, 2023, which are hereby incorporated herein by reference in their entirety.

### FIELD OF INVENTION

The present invention generally relates to an apparatus and several methods for risk modeling and benefit payout methodology for insurances, and specifically for providing and administering a cooperative life insurance.

### DISCUSSION OF RELATED ART

Various life insurance models are known in prior art such as whole life, universal life, term life and deferred life insurance. The insurance in all these options guarantees a fixed benefit (generally, ‘payout’) to be paid regardless of the amount of collected premium contributions (generally, ‘contribution’) by the underwriter (generally, ‘insurance company’) to a beneficiary upon the death of the insured or policyholder (generally, ‘insured’). This method is referred to as ‘sum-assured’. The life insurance premium amount is determined for a specific ‘sum’ after gathering personal information (such as age, gender, profession and location) on the insured as well as using medical examination results. Obtaining such insurance would not be a problem when the insured is young and healthy. Over time, however, a person's health generally declines, or the person ages in which case obtaining a policy with a reasonable premium becomes impossible. Thus, a person is placed in the difficult position of obtaining a second policy at a substantially higher premium or, alternatively, being declined the second policy. Some insurance types keep policy premiums stable, i.e., do not increase with age, but offer at an exorbitant premium throughout the term.

Term life insurance is yet another option as a prior art solution that involves payment of a payout in the event of the insured's death during a specified term (e.g., five years). Thus, a term life insurance policy is temporary. When the policy expires and the insured is still alive, the collected premium during the term is usually not returned. For the same amount of payout, the aging insured has an option of renewing the insurance for another term at a higher premium.

A prior art option to term insurance is deferred life insurance, as described in U.S. Pat. No. 8,589,147 which allows the policy to mature at a deferred time interval (so-called second period later in life). Another option is a renewable term life insurance wherein the policyholder requalifies to continue with an extended term. Yet another type of insurance is whole life insurance, which provides coverage throughout the life of the insured. The cash value portion of a whole life insurance policy belongs to the insured and may be withdrawn as a loan, however, any loans and interest charges accrued on the loans that are not paid back will significantly reduce the payout.

A hybrid life insurance model is described in U.S. Pat. No. 8,180,656 B2 wherein the payout comprises a fixed minimal payout component as well as a variable component. The insured determines the allocation of premium payments between the fixed account and variable account and can vary from time to time. The variable component is invested by the insured into different classes of assets. Two insured with the same premium, therefore, may experience different payout levels due to the variable component.

The classical insurance types enumerated above, all well-known in the prior art, suffer from several disadvantages. The insurance policy is rigid and lacks flexibility. The benefit differs wildly (although it is sum-assured) because the policies lack the fundamental guarantee that the policy will be in force unless a sufficient amount of premium has been paid. In other words, these types of insurance are bound to lapse unless the insured has made a significant amount of contribution. As a result, older people or even people with considerable free cash available to pay such premiums can't afford to have life insurance.

Another disadvantage of traditional life insurance models, without exception, is that the total risk is transferred from the insured to the insurer. The relationship between the insurance company and each insured is one-to-one. There is no relationship between the group of insured. Policyholders are considered as ‘customers’ and premiums as ‘revenue’. Meaning that premiums are fully owned by the insurance company. The underwriting surplus is also owned by the insurance company. The profitability rewards the company's shareholders as increased stock price or dividend payment. The insured gets no benefit from the profitability of the insurance company.

Besides these traditional life insurances, there is an insurance model used in the Islamic world, which is compliant with Sharia rules. These rules that are clearly specified in the Quran prohibit (i) interest revenue, (ii) excessive speculation and risk-taking, and (iii) financial gambling. These rules leave the large Islamic community in the world outside the scope of traditional life insurance. As a result, insurance penetration among Muslim countries is much lower than in the rest of the world.

Islamic financial products based on trading and managing assets require that these assets be insured through an Islamic insurance company if one is available. Consequently, there is a growing need in many Muslim countries to have an alternative solution to their insurance needs. Unfortunately, there is only limited availability of such insurances. Similarly, there is a growing need for Shariah-compliant financial banking. However, there are only a few models and a limited number of publications on how to perform asset management. A partnership method for Islamic profit sharing in banking is described in WO patent application 2020/112061A1.

A historic Islamic insurance model, known as ‘Takaful’, has recently become more popular and is being implemented in many countries that address the shortcomings of traditional life insurance. Takaful is a practice whereby participants in a group jointly agree to guarantee themselves against a loss or damage. In Takaful, policyholders are the owners of the fund. The beneficiary receives financial aid from the fund that is determined based on the policy. The amount is drawn out of the common fund. For that reason, it is a collaborative insurance model. The funds are used (i) to compensate the Takaful Operator (the company that manages the funds on behalf of the participants to obtain profit), (ii) for claim payouts, (iii) for the fund's day-to-day operational expenses, and the remainder of the fund's money is used for investment. In case there are funds remaining after the aforementioned activities, they are partially redistributed back to policyholders. Meaning that all participants may receive a portion of the underwriting surplus. Although there is not a wide list of references, there are a few publications on Takaful such as “Islamic Takaful: Business Models, Shariah Concerns, and Proposed Solutions,” by A. Wahab et al. and “Challenges of Islamic Insurance (Takaful) Globally,” by M. Saeed. Another prior art is the WO patent application 2006/103471A2 which describes a business method to transfer risk in a Takaful insurance through multiple Takaful Operators.

From a surplus redistribution perspective, Takaful may look like a form of crowdfunding (or mass funding), e.g., as described in U.S. Pat. No. 9,830,651, wherein a group of people participate to fund a company, and, in return, receives dividends, products or service from the company. However, Takaful life insurance is distinctly different than crowdfunding as the participant's benefit is determined based on the personal profile of the participant. Meaning, two participants contributing exactly the same premium receive different levels of benefit. In stark contrast, crowdfunding benefits have no bearing on the contributor's personal profile. There are no models or systems that use Takaful as a form of financial operations based on crowdfunding.

In the classical life insurance model, the policyholder doesn't care for the others that are insured. In contrast, Takaful is built on the principle that the policyholder not only pays a premium for his beneficiary's protection but also for assisting others participating in the fund, hence the collaborative aspect. Community pooling spreads the liability and losses among members.

There are several known models (e.g., Mudarabah, Wakala and Waqf) for Takaful as described in the non-patent literature to M. Saeed. The Takaful models primarily differ from the point of view of business administration of the fund, and more specifically, distinguished by the methods of investment of the fund's common pool whether it is an external fund operator or handled internally, but the general philosophy of the insurance remains the same. A noteworthy addition to the prior art is “Takaful industry and Blockchain: challenges and opportunities for costs' reduction in Islamic insurance companies,” by M. Radwan, where a blockchain-based Takaful model is mentioned to improve transparency and security of the fund.

Despite aforementioned advantages, Takaful suffers severely from several deficiencies. In all prior art Takaful models, the insured is guaranteed a certain ‘sum-assured’ amount in the event of a claim (see the website www.takafulemarat.com/life-insurance/as a real-life example). The amount is determined at the initial underwriting of the policy and is not conditional on total contributions being made. Meaning, the benefit does not change over time. A minimum term for premium payments for qualifying a payout is specified, just as in traditional insurance models. The sum-assured policy stays the same regardless of the performance of the fund. The risk is essentially transferred to the Takaful Operator for the fund's avoidance of excessive risk-taking. The redistribution of surplus/profit by the Takaful Operator is at the end of the fiscal year-end, not when the policyholder requests the redistribution, and at the discretion of the operator. In case of an underwriting deficit that may arise due to a sum-assured approach under a scenario with much higher than estimated claims volumes, the prior art Takaful operator must obtain a no-interest loan to the Takaful fund instead of sharing the risk with participants.

The present invention overcomes various shortcomings of the conventional life insurance models and the Takaful model. Here, novel cooperative life insurance methods and systems are described with a variable payout that rewards participation and the fund's overall success and distributes both risks and rewards fairly. The model provides a high level of flexibility to the insurance fund as well as the insured leveraging the collaborative aspects of Takaful.

### SUMMARY OF THE INVENTION

In one embodiment, the present invention provides an article of manufacture having a non-transitory computer readable storage medium comprising computer readable program code executable by a processor to implement a method of a cooperative life insurance fund with a variable payout, a plurality of participants participating in the cooperative life insurance fund, the non-transitory computer readable storage medium comprising: (a) computer readable program code receiving a request for participation in a fund for a term from a user, the request comprising a payout and a plurality of information associated with the user; (b) computer readable program code evaluating the plurality of information associated with the user and verifying an eligibility of the user in the cooperative life insurance fund and, upon verifying eligibility, enrolling the user as a participant among the plurality of participants and generating a policy for the participant for the requested term, wherein the policy specifies a contribution by the participant and a base benefit multiplier, and wherein a payout to a beneficiary of the participant is computed by setting aside a management fee from the contribution by the participant during a time period from a beginning of the term until a time of claim payout, and multiplying a remainder of the contribution by the participant with the base benefit multiplier and a benefit adjustment factor, whereby: the base benefit multiplier is computed using a discrete non-linear function that varies according to one or more information in the plurality of information; the benefit adjustment factor is computed to be proportional to a difference between a performance of the cooperative life insurance fund at the time of beneficiary payout and a projected fund performance at the beginning of the term; (c) computer readable program code periodically collecting, over a first pre-determined time interval, a payment for the contribution from the plurality of participants; (d) computer readable program code periodically computing, over a second pre-determined time interval, the benefit adjustment factor for the cooperative life insurance fund to adjust payouts; and (e) computer readable program code determining when a payout is deemed necessary to a given beneficiary associated with a given participant among the plurality of participants, and determining a given claim payout and transferring the given claim payout to the given beneficiary and eliminating the given participant among the plurality of participants associated with the cooperative life insurance fund.

In an extended embodiment, the plurality of information associated with the user comprises any of, or a combination of, the following: age, gender, occupation, location, lifestyle, and health condition of the user.

In an extended embodiment, the non-transitory computer readable storage medium further comprises: (a) after setting aside the management fee, for each participant, computer readable program code maintaining a balance in a claims reserve and a fund reserve according to a pre-determined reserve ratio, wherein funds in the claims reserve and fund reserve are used to pay claims, and wherein the fund reserve has strictly unearned premium, and the claims reserve has both unearned and earned premiums; (b) computer readable program code transferring a portion of fund reserve to a fund operator for investment purposes; (c) computer readable program code receiving periodically, from the fund operator, investment income; (d) computer readable program code adding, the investment income to the cooperative life insurance fund; (e) computer readable program code determining, as a surplus, an earned premium component of the claims reserve remaining after an actual as well as an expected claims are paid out for a time period; and (f) computer readable program code redistributing a portion of the cooperative life insurance fund as surplus to each participant within the plurality of participants at a term end in form of a cash return proportional to the ratio of total contributions made by each participant to the total contributions collected from the plurality of participants who are not paid out.

In an extended embodiment, the predetermined reserve ratio is dynamically readjusted for all new participants and renewing participants when the cooperative life insurance fund reserve falls below a certain threshold compared to its pro forma level due to claims payouts.

In an extended embodiment, the benefit adjustment factor is equal to one if the cooperative life insurance fund's actual performance is the same as or better than the projected fund performance at the beginning of the policy, and slightly less than one if the cooperative life insurance fund's actual performance is worse than the projected fund performance.

In an extended embodiment, the actual and projected performances are determined using any of, or a combination of, the following: a shortfall method, a cashflow method, and a loss ratio method.

In an extended embodiment, the shortfall method is as follows:

$$AF ( T ) = \{ \begin{matrix}1 ; & Pa \leq Pe \\ ( Cr + k \times Fr - ( Pa - Pe ) ) / ( Cr + k \times Fr ) ) ; & Pa > Pe\end{matrix}$$

where
Pa—total actual claims,
P—total projected claims at underwriting,
(Pa−Pe)—shortfall of total claims,
Cr—current claims reserve,
Fr—current fund reserve, and
k—a scalar determining the portion of Fᵣ used for claim payouts.

In an extended embodiment, the scalar k is 0.7.

In an extended embodiment, the cash flow method is as follows:

$$AF ( T ) = \{ \begin{matrix}1 ; & ( Cfia + Cr ) \geq ( Cfoa + Crpf ) \\ ( Cr + k \times Fr + Cfia ) / ( Crpf + k \times Fr + Cfoa ) ; & otherwise\end{matrix}$$

where
Cfia—cash in expected over the next 12 mo. through contributions from renewals and new policies
Cfoa—cash out expected over the next 12 mo. through payments of claims
Crpf—pro-forma Cr
Pa—total actual claims,
P—total projected claims at underwriting,
(Pa−Pe)—shortfall of total claims,
Cr—current claims reserve,
Fr—current fund reserve, and
k—a scalar determining the portion of Fr used for claim payouts.

In an extended embodiment, the scalar k is 0.7.

In an extended embodiment, the loss-ratio method is as follows:

$$AF ( T ) = \{ \begin{matrix}1 ; & LRa \leq LRe \\ 1 - ( Lra - Lre ) ; & LRa > LRe\end{matrix}$$

where
Lra—current loss ratio at T, and
Lre—loss ratio threshold.

In an extended embodiment, the non-transitory computer readable storage medium further comprises computer readable program code terminating a first participant's policy after an expiration of an associated term, and returning to said first participant, a share of a surplus.

In an extended embodiment, the share of the surplus is computed as follows:

$$BS ( T 3 , i ) = Sf ( T 3 ) \times [ {\sum }_{T}^{T 3} C ( i ) / {\sum }_{i} {\sum }_{T}^{T 3} C ( i ) ]$$

where
BS(T3, i)—the surplus benefit payable to policyholder-(i) at time point T3
Σ_{T}^{T3} C(i)—The total contributions paid by policyholder-(i) from T to T3
Σᵢ Σ_{T}^{T3} C(i)—The total contributions paid by all active policyholders and not paid out from T to T3, and
Sf (T3)—The total surplus in the fund at T3.

In another embodiment, the present invention provides a system comprising: (a) a processor; (b) storage storing computer readable programmable code executable by the processor, the storage comprising: (i) computer readable program code receiving a request for participation in a fund for a term from a user, the request comprising a payout and a plurality of information associated with the user; (ii) computer readable program code evaluating the plurality of information associated with the user and verifying an eligibility of the user in the cooperative life insurance fund and, upon verifying eligibility, enrolling the user as a participant among the plurality of participants and generating a policy for the participant for the requested term, wherein the policy specifies a contribution by the participant and a base benefit multiplier, and wherein a payout to a beneficiary of the participant is computed by setting aside a management fee from the contribution by the participant during a time period from a beginning of the term until a time of claim payout, and multiplying a remainder of the contribution by the participant with the base benefit multiplier and a benefit adjustment factor, whereby: (1) the base benefit multiplier is computed using a discrete non-linear function that varies according to one or more information in the plurality of information; and (2) the benefit adjustment factor is computed to be proportional to a difference between a performance of the cooperative life insurance fund at the time of beneficiary payout and a projected fund performance at the beginning of the term; (iii) computer readable program code periodically collecting, over a first pre-determined time interval, a payment for the contribution from the plurality of participants; (iv) computer readable program code periodically computing, over a second pre-determined time interval, the benefit adjustment factor for the cooperative life insurance fund to adjust payouts; and (v) computer readable program code determining when a payout is deemed necessary to a given beneficiary associated with a given participant among the plurality of participants, and determining a given claim payout and transferring the given claim payout to the given beneficiary and eliminating the given participant among the plurality of participants associated with the cooperative life insurance fund, (c) a database to store participant profiles, accounts, policies and security settings, and historic and present insurance fund information including pool, surplus and investments; and (d) a communications interface to communicate with at least a fund operator's system, a participant's client application, and a payment gateway.

In an extended embodiment, the benefit adjustment factor is equal to one if the cooperative life insurance fund's actual performance is the same as or better than the projected fund performance at the beginning of the policy, and slightly less than one if the cooperative life insurance fund's actual performance is worse than the projected fund performance.

In an extended embodiment, the actual and projected performances is determined using any of, or a combination of, the following: a shortfall method, a cashflow method, and a loss ratio method.

In an extended embodiment, the shortfall method is as follows:

$$AF ( T ) = \{ \begin{matrix}1 ; & Pa \leq Pe \\ ( Cr + k \times Fr - ( Pa - Pe ) ) / ( Cr + k \times Fr ) ) ; & Pa > Pe\end{matrix}$$

where
Pa—total actual claims,
P—total projected claims at underwriting,
(Pa−Pe)—shortfall of total claims,
Cr—current claims reserve,
Fr—current fund reserve, and
k—a scalar determining the portion of Fᵣ used for claim payouts.

In an extended embodiment, the cash flow method is as follows:

$$AF ( T ) = \{ \begin{matrix}1 ; & ( Cfia + Cr ) \geq ( Cfoa + Crpf ) \\ ( Cr + k \times Fr + Cfia ) / ( Crpf + k \times Fr + Cfoa ) ; & otherwise\end{matrix}$$

where
Cfia—cash in expected over the next 12 mo. through contributions from renewals and new policies
Cfoa—cash out expected over the next 12 mo. through payments of claims
Crpf—pro-forma Cr
Pa—total actual claims,
P—total projected claims at underwriting,
(Pa−Pe)—shortfall of total claims,
Cr—current claims reserve,
Fr—current fund reserve, and
k—a scalar determining the portion of Fr used for claim payouts.

In an extended embodiment, the loss-ratio method is as follows:

$$A F ( T ) = \{ \begin{matrix}1 & ; & LRa \leq LRe \\ 1 - ( L r a - L r e ) & ; & LRa > LRe\end{matrix}$$

where
Lra—current loss ratio at T, and
Lre—loss ratio threshold.

In an extended embodiment, the non-transitory computer readable storage medium further comprises computer readable program code terminating a first participant's policy after an expiration of an associated term, and returning to said first participant, a share of a surplus, wherein the share of the surplus is computed as follows:

$$B S ( T 3 , i ) = S f ( T 3 ) \times [ {\sum }_{T}^{T 3} C ( i ) / {\sum }_{i} {\sum }_{T}^{T 3} C ( i ) ]$$

where
BS(T3, i)—the surplus benefit payable to policyholder-(i) at time point T3
Σ_{T}^{T3} C(i)—The total contributions paid by policyholder-(i) from T to T3
Σᵢ Σ_{T}^{T3} C(i)—The total contributions paid by all active policyholders and not paid out from T to T3, and
Sf (T3)—The total surplus in the fund at T3.

### BRIEF DESCRIPTION OF FIGURES

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is an example showing key interfaces of the system of invention.

FIG. 2 illustrates partitioning of the contribution into reserves according to invention.

FIGS. 3a and 3b are exemplary BBM functions according to invention.

FIGS. 4a and 4b are exemplary functions showing actual and projected payouts over time.

FIG. 5a is the benefit adjustment factor over time using shortfall method.

FIG. 5b is the benefit adjustment factor over time using the cash flow method.

FIG. 5c is the benefit adjustment factor over time using the loss ratio method.

FIG. 6 is an exemplary flowchart of the method of invention for computing payout.

FIG. 7 shows the key components of the life insurance system according to invention.

FIG. 8 shows the AI engine according to invention.

FIG. 9 shows the AI engine training system according to invention.

FIG. 10 is a mock dashboard of the system of invention.

Skilled professionals will appreciate that elements in the figures are illustrated for simplicity and clarity and have not necessarily been drawn to scale. Also, common but well-understood elements that are useful or necessary in a commercially feasible embodiment are often not depicted to facilitate a less obstructed view of these various embodiments of the present invention. Flowchart and block diagrams in the figures illustrate the functionality and operation of possible implementations of systems, methods and computer program products according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### DETAILED DESCRIPTION

The detailed descriptions contain explanations, formulas, diagrams, and flowcharts that are provided purely to enhance the understanding of the system components and the methods, and thus they may not describe all details or illustrate all trivial blocks and steps that would be understood by those persons skilled in art. Some of the figures are presented only for clarifying the terminology or to explain the prior art in contrast to present invention.

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Various modifications to embodiments will be readily apparent, and the generic principles defined herein may be applied to other aspects. Thus, the invention is not intended to be limited to the aspects shown herein, but is to be accorded the full scope consistent with the language claims, where reference to an element in the singular is not intended to mean ‘one and only one’ unless specifically so stated, but rather ‘one or more.’ Unless specifically stated otherwise, the term ‘some’ refers to one or more. Pronouns in the masculine (e.g., his) include the feminine and neuter gender (e.g., her, they and its) and vice versa. Headings and subheadings, if any, are used for convenience only and do not limit the subject technology.

A phrase, for example, an ‘aspect’ does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a ‘configuration’ does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the invention.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described below should not be understood as requiring such separation in all embodiments, and the described program components and systems can generally be integrated together in a single software product or packaged into multiple software products.

As noted above, embodiments of the subject matter have been described, but other embodiments are within the scope of the following claims. For example, the actions recited in the claims can be performed in a different order and still achieve desirable results. As one example, the processes depicted in the accompanying figures do not necessarily require the order shown, or sequential order, to achieve desirable results. In certain implementations, multitasking and parallel processing may be advantageous.

Note that in this description, references to ‘one embodiment’ or ‘an embodiment’ mean that the feature being referred to is included in at least one embodiment of the invention. Further, separate references to ‘one embodiment’ in this description do not necessarily refer to the same embodiment; however, such embodiments aren't mutually exclusive, unless so stated and except as will be readily apparent to those of ordinary skill in the art. Thus, the present invention can include any variety of combinations and/or integrations of the embodiments described herein.

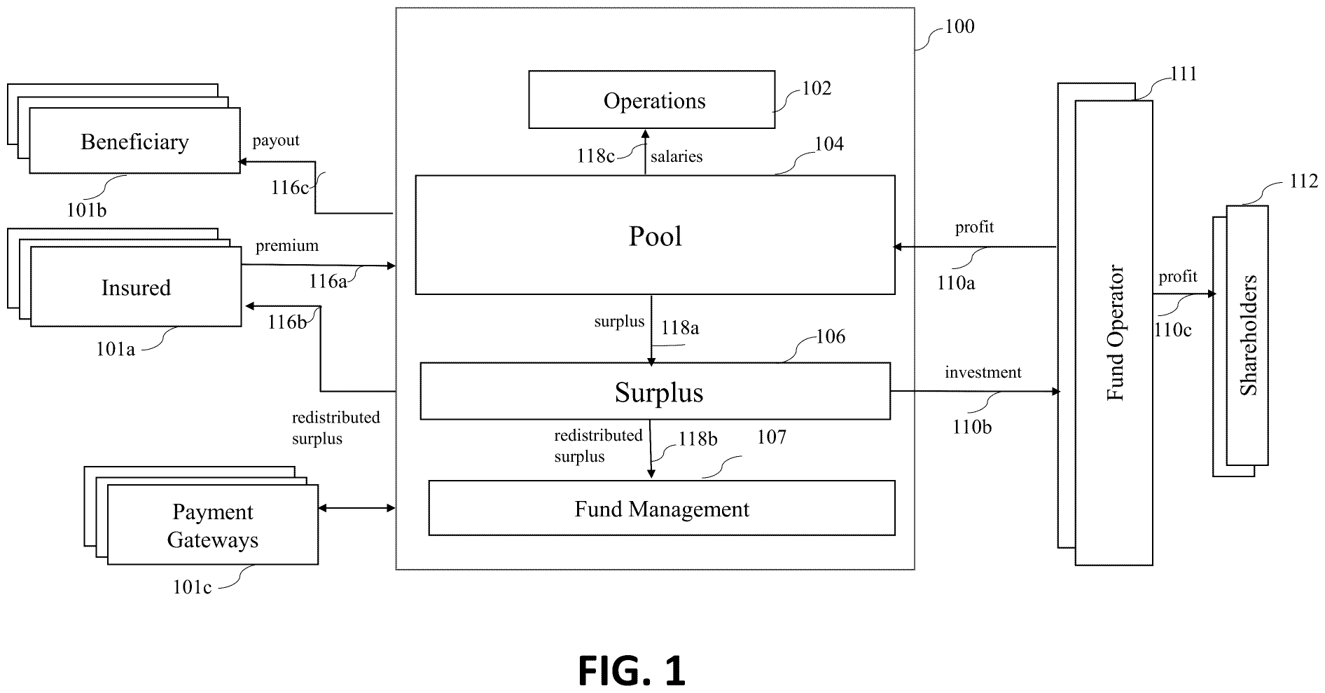

FIG. 1 illustrates a high-level block diagram of the system of invention. One of the key differentiators between this invention and traditional Takaful is that there are two separate and independent entities: Insurance Fund 100 and Fund Operator 111. In stark contrast, there is only one entity in traditional Takaful, aka the Takaful Operator, who represents both themselves and the participants of the Takaful insurance fund. The traditional Takaful operator owns and manages the fund. The participants have no legal authority to take part in the management of the Takaful fund. According to this invention, there is at least one separate Fund Operator 111 that manages the fund's income making investments wherein these investments can be Shariah-compliant in an Islamic country. Fund Operator 111 returns profit 110c to its shareholders 112 as well as Insurance Fund 100 in the form of profit sharing 110a. In one embodiment, Fund Operator 111 is a business entity that performs investments exclusively for Insurance Fund 100. In another embodiment, Fund Operator 111 is a business entity that performs investments for a plurality of businesses and not exclusively the Insurance Fund 100. Insurance Fund 100 sends a portion of the fund, 110b, to Fund Operator 111 for investment purposes. According to an aspect of this invention, Insurance Fund 100 is an independent entity that is owned and managed by all policyholders (insureds) 101a. Each insured is part-owner of Insurance Fund 100 and owns equity that is based on their total contributions. The longer or more they contribute the higher the equity gets. In the same way, if an individual owns shares in a company, he/she is part owner of the company. The income generated through collected premiums is legally owned by Insurance Fund 100. The fund may then appoint one or more Fund Operators to manage the income on their behalf. By the same token, the fund can fire Fund Operator 111.

According to an aspect of this invention, the underwriting surplus, which is the leftover money in the fund after claims are paid, investment returns are realized, and future claims are accounted for with a high confidence interval, is owned by the fund. Each participant has a legal right to the surplus which they can claim according to predefined rules agreed upon by the fund. The fund is comprised of pool 104 that collects the premiums 116a from all insured 101a. Each insured 101a has a declared beneficiary 101b who collects the payout 116c in case insured 101a dies. Insured 101a also collects a variable amount of redistributed surplus 116b if the fund has a surplus and the participant has not made a successful benefit claim before.

Pool 104 is divided into three portions: a portion is to pay the fund's costs. Another portion is the ‘earned premium’ collected from participants, and the remainder is the ‘unearned premium’. Earned premium, well known in prior art, refers to the portion of the paid premium that has been earned by the insurance company. It is the portion of the premium for the duration that the policy has been in place. The insurance company has fulfilled its obligation by providing coverage for that duration. Earned premium is considered earnings by the insurance company. The remainder portion is unearned premium. Furthermore, a portion of the pool is used to pay claims (payouts) in the form of two reserves, namely ‘claims reserve’ and ‘fund reserve’, which are also well-known in traditional insurance literature. A portion of the ‘claims reserve’ is Surplus 106. A portion of the ‘fund reserve’ is transferred to Fund Operator 111 for investment, 110b. The investment return (profit) 110a goes back into Pool 104.

Pool 104 is used to pay all operational expenses of Operations 102 of the fund including salaries 118c. The remainder from the pool, 118a, is transferred to Surplus 106. Operations 102 manages the day-to-day operations including management of computer and IT infrastructure of the fund and providing participant support services. Surplus 106 and underwriting are managed by Fund Management 107 which is employed by the Fund. Surplus is redistributed to participants as well as Fund Management 107. 118b is the redistributed surplus to Fund Management 107. This organization may perform financial support services for participants as well. The Board of Directors of the fund is chosen from the participants.

Because the fund bears all the risks and rewards of insurance activities, it is considered a risk-sharing arrangement. As such, it is not regulated as a traditional insurance company since insurance contracts are defined as risk-transfer contracts. Instead, the fund is regulated as a non-profit organization or reciprocal ‘self-insurance’ company where such legal structures exist. Recall that as per Shariah requirements, the contributions are considered donations for a specific purpose. On the other hand, Fund Operator 111 is a for-profit entity that acts as a service provider to the fund that is engaged by the fund and manages investment activities.

In an alternative embodiment, Fund Operator 111 may undertake all or part of the operational functions on behalf of the fund that is represented by Operations 102 and all or part of the financial activities on behalf of the fund including underwriting represented by Fund Management 107. In yet another alternative embodiment, a separate entity from Fund Operator 111 may be responsible for the operational functions on behalf of the fund that is represented by Operations 102 and all financial activities on behalf of the fund including underwriting represented by Fund Management 107.

Payment Gateways 101c are used to electronically transfer funds between Fund Management 107 and other entities such as the insured 101a and beneficiary 101b.

It is understood that there are terms used interchangeably depending on the specific business arrangement of the fund whether it is a licensed insurance company or a cooperative for mutual protection (aka unlicensed insurance arrangement). Accordingly, the terms ‘insured,’ ‘policy,’ and ‘premium’ that are used in insurance nomenclature may be used interchangeably throughout the document with ‘participant,’ ‘membership,’ and ‘contribution,’ respectively, that are used in cooperative nomenclature. Similarly, from time-to-time terms ‘payout,’ ‘claim,’ and ‘benefit’ are used interchangeably.

The payout is determined by the insured's contributions to the fund. The premium (contribution) is paid by the insured according to his/her policy. The premium is typically defined on a yearly basis. A prospective insured can set their contribution or their payout (benefit) to a desired level, whereby the ratio between these two remains unchanged based on the benefit multiplier. The ‘net premium’ is the remainder of the premium after the management fee of the fund is subtracted. It is the amount of money that remains to cover future claims and other obligations. The management fee is also known as the ‘wakala fee’ in Takaful literature. As an example, if the ‘wakala fee’ is 20%, then the corresponding net premium is 80% of the paid premium. The premium is determined at the time of underwriting and remains constant throughout the life of the term (membership) which guarantees the insurance's continuation as the insured ages throughout the term. For example, during a 5-year term, the contribution to obtain a certain benefit doesn't change per year and will be re-calculated if the member decides to enter into a new term at the end of the 5-year period.

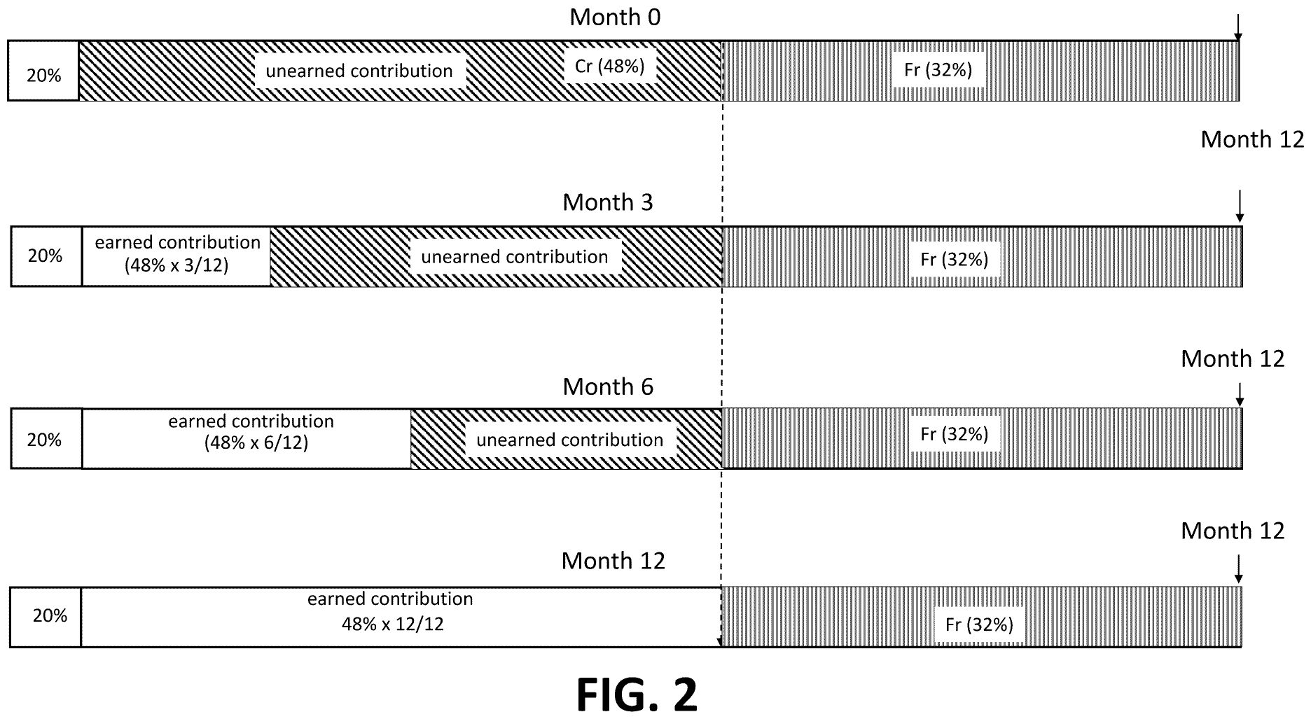

The fund's solvency is enforced by setting aside one or more reserves for payouts. An exemplary reserve strategy, according to an aspect of this invention, is depicted in FIG. 2 wherein two types of reserves, denoted as Cr and Fr, are used. The percentage of the collected net premium (contribution) that is set aside for claim payouts is called ‘claims reserve’ and denoted as Cᵣ. The second reserve is the ‘fund reserve,’ denoted as Fᵣ. The fund reserve (Fᵣ) is set aside to enable payment of claims exceeding the expected claims frequency and severity based on the fund's membership characteristics. Typically, there is a well-known ratio of total payouts to total contributions according to actuarial assessments, taking into account mortality rates, policy terms, expected claims, and timing of claims. That typical ratio can be used to determine the ratio of Cᵣ to Fᵣ, which can be adjusted from time to time. The claims reserve and fund reserve constitute the total reserve of the fund.

FIG. 2 shows an example scenario with the two reserves assuming a wakala fee of 20% and the ratio of Cr to the net contribution of 60%. Meaning 60% of the net contribution, that is 80% of the contribution, i.e., 80×60%=48% goes to Cᵣ. The remainder portion of the net contribution, i.e., 80×40%=32% goes to fund reserve, Fᵣ. Each participant's contributions are partitioned accordingly and added to these two reserves. The claims reserve is used for the payout. If total payouts exceed the total amount of money collected in the claims reserve of the fund, payouts are supplemented from the money in the fund reserve, which consists of all participants' fund reserve additions, collected as part of each member's net contribution. The earned contribution is calculated only over the claims reserve portion and is earned on a pro-rata basis every month (assuming a yearly premium). The contribution allocated to the fund reserve is not earned by the insurance company and is not used for surplus calculation purposes. The claims reserve is comprised of ‘earned’ and ‘unearned’ components. The earned claims reserve component refers to any part of the claims contribution that is earned by the insurance company over time and used for surplus calculations. The unearned claims reserve component is earmarked for the payout of claims during the remainder of the member's membership year, and that is required to be paid back to the policyholder if the coverage is terminated before the expiration date. Therefore, the unearned claims reserve is the liability of the fund. According to FIG. 2, the earned claims reserve component of the premium at month 3 is 12%=3/12^{th}×48%. The remainder, i.e., 36%=9/12^{th}×48%, is the unearned claims reserve component. At month 12, the entire claims reserve becomes earned.

According to the first aspect of this invention, the method of Dynamic Reserve Ratio (DRR) is introduced to adjust the ratio of Cᵣ and Fᵣ over time. Doing so, the percentage of the net contribution set aside for Cᵣ changes according to the fund's performance. This is triggered when the fund reserve has been used to supplement claims reserve for payouts and falls below a certain threshold compared to its pro forma level, which is defined as the size of the fund reserve if it has not been used for payouts. The ratio (split) of claims reserve and fund reserve partitioning of net contribution is readjusted for all new members and renewing members, to allow the fund to regain its original Fᵣ level. As a result, the percentage of the net contribution allocated to Fᵣ is set parametrically and varies from time to time to ensure the solvency of the fund. While this impacts Cᵣ for a member, their benefit is calculated over the pro forma Cr, defined as what Cᵣ would have been if the fund's initial reserve ratio was used.

In an exemplary case shown in FIG. 2, with an annual premium of 100 with a wakala fee of 20% and DRR of 40%, the distribution of the contribution to the two reserves is as follows:

At day 1:
20 (20% of 100) goes into the wakala fee
80 (80% of 100) is the net contribution
32 [(80)×(40%)] goes into the Fund Reserve, Fᵣ
48 [(80)×(100%-40%)] goes into the Claims Reserve, Cᵣ

At month 3:
20 (20% of 100) goes into the wakala fee.
32 (80×40%) remains in the fund reserve, Fᵣ
48 (80×60%) remains in the claims reserve, Cᵣ
12 (48×3/12) is earned contribution in Cᵣ
36 (48-12) is unearned contribution in Cᵣ

At year-end:
20 (20% of 100) goes into the wakala fee.
32 (80×40%) remains in the fund reserve, Fᵣ
48 (80×60%) remains in the claims reserve, Cᵣ
48 (48×12/12) is earned contribution in Cᵣ

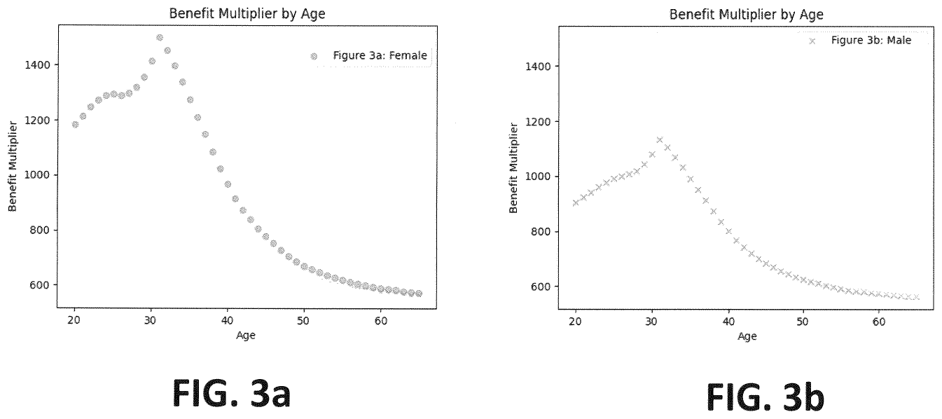

According to the second aspect of this invention, the benefit is determined by multiplying the participant's net contribution by the ‘benefit multiplier,’ which is a function of two components, namely the ‘base benefit multiplier (BBM)’ and the ‘benefit adjustment factor (AF)’. The initial BBM is determined at underwriting from the insured's personal profile, such as age, gender, occupation, location, lifestyle factors such as tobacco use, body mass index (BMI), and health. The BBM varies over time as the insured gets older, changes location or job, or his/her health changes. Mathematically, the BBM is represented as a multi-variable non-linear function. Meaning that there is a different non-linear BBM function by the variable type, namely gender, location, job type, lifestyle and health condition. These variables are collectively known as the personal profile of the insured. Each BBM function (that depends on a single variable) is dependent on the age of the insured and may further be flattened in age intervals, as illustrated in FIG. 3a, say for every five years once a new membership period begins. In that respect, the BMM function has discrete values. As an example, for a man at age 40, there is a single BBM calculated for ages 40 to 44. However, when he renews his membership at 45 years old, the BBM is reduced to the next cluster value (of the next age group) corresponding to the five-year interval of 45 to 49.

The age-group cluster values may differ according to gender and geographic location. As an example, the BBM for a female is usually higher than that of a male for the same age-interval comparing FIG. 3a with FIG. 3b, as females statistically live longer. Different BBM functions apply according to other personal profile variables. A twenty-five-year-old non-smoker living in a Western country and working in a low-stress office environment may be assigned a BBM of 1500, whereas a twenty-five-year-old smoker living in a third-world country and working in construction may be assigned a BBM of 800, although both of them are the same age group.

At underwriting, an individual applicant is first evaluated based on his personal profile to determine the applicable BBM. It should be noted that “evaluation” in this context refers to ‘risk classification’ a concept that is well known in the prior art. For example, by reviewing medical information (such as illness history and most recent medical test results) and non-medical information (age, gender, location, profession, tobacco use, etc.) a determination may be made on each individual as to how long he/she will likely live. The better the rating of the profile, the lower the risk and the higher the ensuing base benefit multiplier. Such rating schemes are known in prior art and determined by mortality rates and actuarial risk analyses. The results of the rating schemes are mapped onto BBM functions. Each BBM function's age group cluster value may have minimum, maximum, and average values to provide a range during underwriting.

According to the third aspect of this invention, the benefit is adjusted based on the fund's overall performance at the time of the benefit. The better the fund performs, the higher the benefit, and vice versa. This is achieved by multiplying the total contributions by a ‘benefit adjustment factor’ (generally, ‘adjustment factor’) in determining benefit. The objective of all underwriting and risk management activities is to prolong the life of the fund and ensure solvency. To de-risk the fund and to provide maximum transparency to the participants, the benefit fluctuates within an expected range, according to the performance of the fund. In any insurance-type product, there are expected losses that are incurred from claims, called the ‘loss ratio’. The loss ratio is based on the amount of risk that is taken as a result of the underwriting process. In its simplest form, it is calculated as the ratio of benefits and other costs to the contributions collected by the fund over a period of time. There is a statistically known level for loss ratio in traditional life insurance such as 20-40%. However, if all of the policies are for senior citizens, the loss ratio is expected to be much higher as the death rates will be higher than if all the policies are insuring young healthy adults.

The adjustment factor that signifies the performance of the fund can be determined using several methods according to this invention. In short, if the fund is performing well, meaning the actual claims match or are below the estimates, the adjustment factor is equal to one. Otherwise, the adjustment factor is slightly less than one. The adjustment factor is essentially a multiplier that reflects the deviation from the expected fund performance. In case reality does not match history, the factor will be adjusted up or down within a given range. It will adjust the benefit payments to restore the financial outflows to expected amounts in order to keep the fund solvent. The solvency of the fund (which results in the ability to honor all claims) is always the ultimate goal of all underwriting and financial decisions undertaken by the fund.

Benchmarking against historical data and existing underwriting models is typically used for projections of performance. At the policy generation, such projections are used to estimate the fund performance at the end of the term. However, based on the evolving demographic distribution of participants and due to other factors, the fund may not perform as estimated. There are many methods known in prior art by which an insurance fund's overall performance can be measured. The exemplary methods presented here are geared for the specific method of computing AF, and do not exclude any variations of these methods, any parametric changes, or using them in combinations thereof, or using other similar methods.
a. Cash flow Methodology: The adjustment factor is proportional to the ratio of the cash flow of the fund, i.e., comparing the sum of money remaining in the current Cᵣ (after claims benefits are paid up to that time point) plus the 70% of Fᵣ plus the expected incoming cash for the remainder of the year through renewals and new memberships, to the sum of the pro forma Cᵣ plus 70% of Fᵣ plus expected yearly outgoing cash to pay claims.
b. The Shortfall Methodology: The adjustment factor is proportional to the ratio of the sum of the fund's Cᵣ plus 70% of Fᵣ minus the amount in which current total claims exceed expected total claims (the ‘shortfall’) to the sum of the fund's Cᵣ plus 70% of Fᵣ.
c. The Loss Ratio Methodology: The adjustment factor is proportional to the difference between the fund's actual performance at the time of beneficiary payout, measured as the ratio of total claims benefit payments to total net contributions and the projected loss ratio set by the fund.

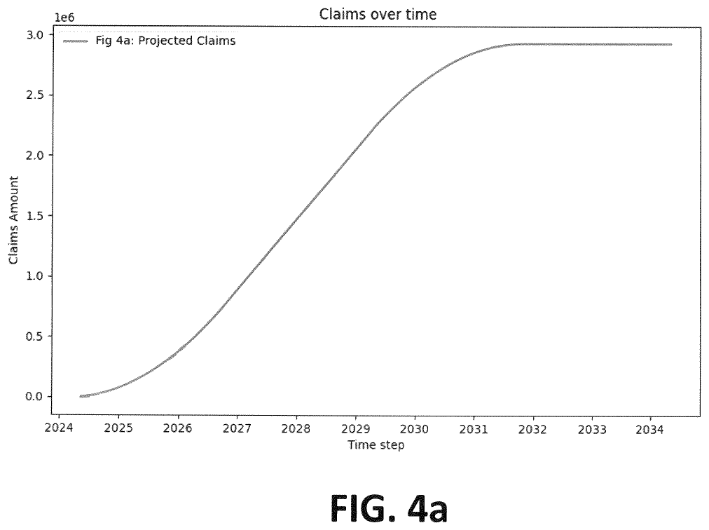

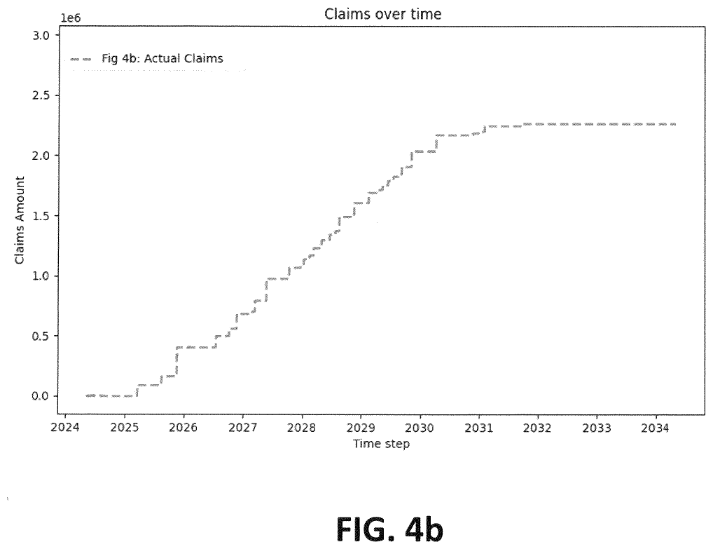

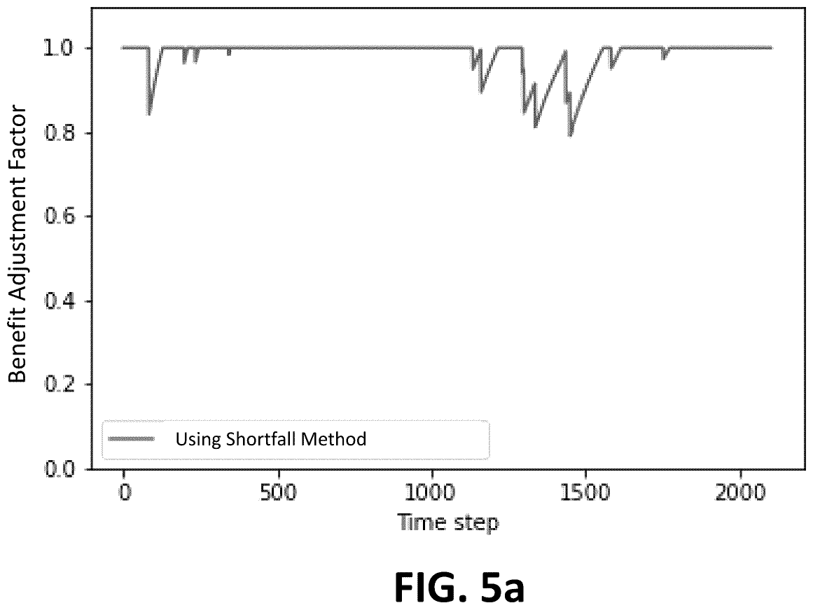

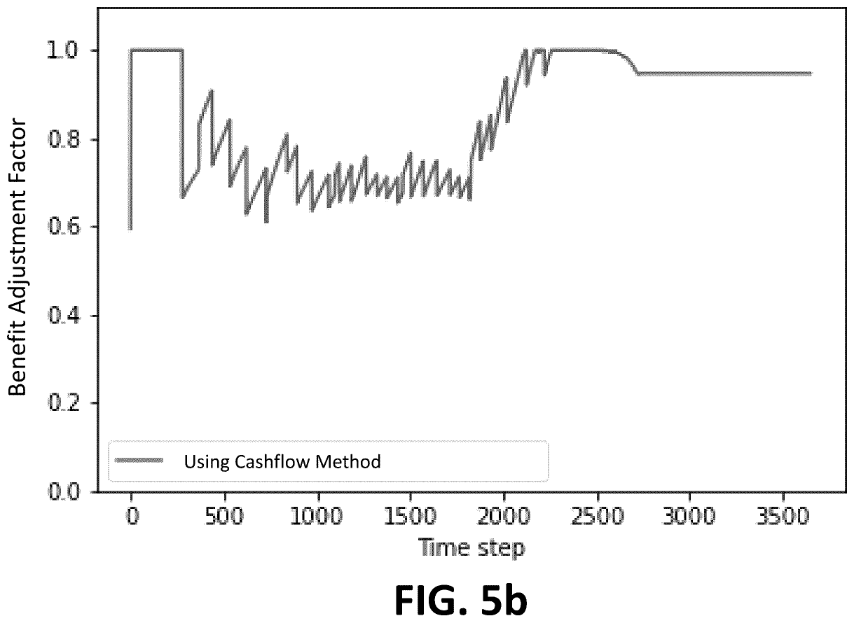

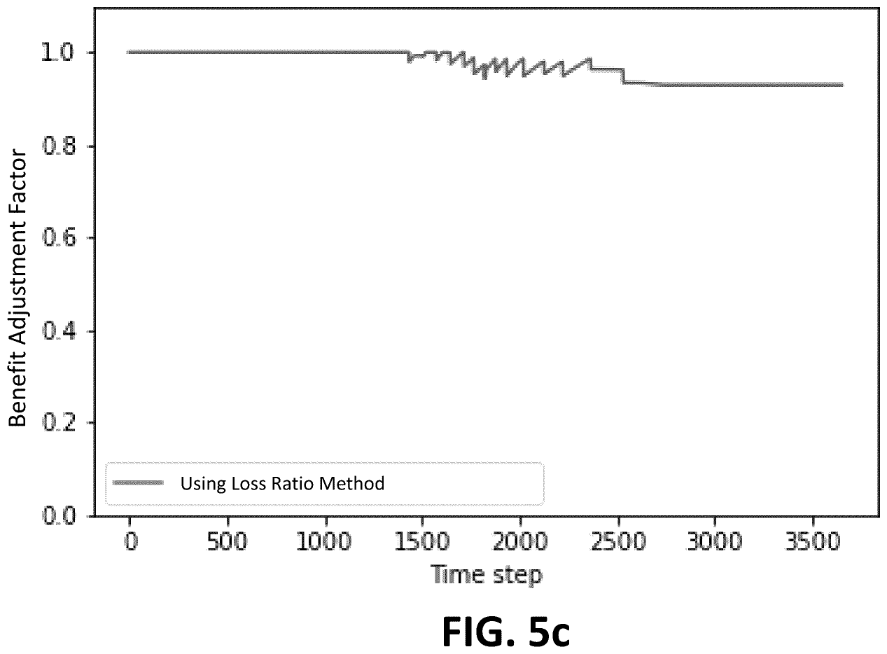

FIGS. 4a and 4b show the projected and realized payouts over time. Correspondingly, FIGS. 5a, 5b, and 5c show the benefit adjustment factor computed using the methods described above.

In an example scenario using the loss ratio methodology, the projected loss ratio for the fund is 40%. In simple terms, it means that we expect 40% of all contributions will be spent on payouts and other costs. Consider a 25-year-old insured with a contribution of $100 and a base benefit multiplier of 150×. In the event that the loss ratio becomes 50%, the benefit payment to his beneficiary will be adjusted downward. While the benefit multiplier will remain 150×, and actual benefit would be $100×150×(1−(50%-40%))=$100×150×0.9=$13,500.

To illustrate the variable benefit payment mechanisms with BBM and AF, consider the following simple examples: The 25-year-old insured has a BBM of 150× with a net contribution of $180/year for 2.5 years. The adjustment factor is 1. He passes away and his family is entitled to a benefit payment of $180×150×1=$27,000.

According to an embodiment of this invention, the formula for the variable benefit payout T time intervals after the coverage start time of policyholder-(i) is given below.

$$B ( i ) = C ( i ) \times Bb m ( i , T 1 ) \times AF ( T ) \qquad ( 1 )$$

where
B(i)—Benefit (payout) of holding the policy i.
Bbm (i,T1)—Base benefit multiplier (BBM) for policyholder-(i) determined at coverage start time T1.
AF(T)—Benefit adjustment factor computed at T.
C(i)—Annual contribution of policy i in the time interval.

Here, Bbm mainly depends on the profile of the policyholder-(i) at underwriting time T1 and does not vary over time during the policy term unless a major change in profile. In one implementation, the Bbm is ‘fixed’ for the 5-year period. A new member at T1 can choose either the amount of contribution, C(i), they want to pay over a term, and the model calculates the B(i), or they can set a B(i), and the model gives them the corresponding C(i). Of course, the B(i) at T1 may be slightly higher than the actual B(i) at time T due to the effect of the AF(T) multiplier. Keeping the term short (as in a 5-year term plan) with annual payments, the ‘surprise’ effect of having to pay more during the term if the term was longer, or to be entitled to a somewhat lower benefit due to reduced Bbm is eliminated.

According to this invention, there may be several embodiments for calculating the adjustment factor. In the ‘shortfall’ method, the adjustment factor is set to 1 (one) when the fund's total claims amount is less than or equal to the projected amount in the policy. Otherwise, it is less than 1 (one). FIG. 5a illustrates the corresponding AF(.) using the shortfall method. This method simply penalizes the payout when the fund underperforms, but does not reward the payout when it outperforms:

$$A F ( T ) = \{ \begin{matrix}1 & ; & P a \leq Pe \\ ( Cr + k \times Fr - ( P a - P e ) ) / ( Cr + k \times Fr ) ) & ; & P a > Pe\end{matrix} \qquad ( 2 a )$$

where

Pa—total actual claims

P—total projected claims at underwriting

(Pa−Pe)—the shortfall of the total claims

Cr—current claims reserve

Fr—current fund reserve
k—a scalar determining the portion of Fᵣ used for claim payouts. Typically, it is set around 0.7.

Assume the participant has a contribution of C(i)=$180 with a Bbm of 100×. At the time of the claim, Cᵣ=$600,000, Fᵣ=$400,000, and Pa=$125,000, while the projected total claim was Pe=$115,000 at the coverage start time. Using k=0.7, the AF(T) is [(600,000+0.7×400,000)−(125,000-115,000)]/(600,000+0.7×400,000)=0.9886. The corresponding benefit payout would be $180×100×0.9886=$17,795.45. Note that the larger the factor k the smaller the impact of the shortfall on benefit computation.

In the Loss Ratio method (see FIG. 5c), the adjustment factor is set to 1 only when the fund has a loss ratio lower than a pre-set threshold. This method penalizes the payout when the fund underperforms:

$$AF ( T ) = \{ \begin{matrix}1 & ; & LRa <= LRe \\ 1 - ( L r a - L r e ) & ; & LRa > LRe\end{matrix} \qquad ( 2 b )$$

where
Lra—current loss ratio at T
Lre—loss ratio threshold

Assume the participant has a contribution of C(i)=$180 with a BBM of 100×. At the time of the claim, Lra=83% and Lre=80%. The AF(T) is computed as [1−(0.83−0.80)]=0.97. Correspondingly, the benefit payout would be $180×100×0.97=$17,460.

In the Cash Flow method (see FIG. 5b), the adjustment factor is set to a minimum of (the current Cᵣ plus the k portion of Fᵣ plus the expected cash-in over the next 12 months) divided by (the pro forma Cᵣ, plus the k portion of Fᵣ plus expected 12-month cash-out through claims).

$$A F ( T ) = \{ \begin{matrix}\begin{matrix}1 ; & ( Cfia + Cr ) \geq ( Cfoa + Crpf )\end{matrix} \\ \begin{matrix}( Cr + k \times Fr + Cfia ) / ( Crpf + k \times Fr + Cfoa ) ; & oth erwise\end{matrix}\end{matrix} \qquad ( 2 c )$$

where
Cfia—cash in expected over the next 12 mo. through contributions from renewals and new policies
Cfoa—cash out expected over the next 12 mo. through payments of claims
Crpf—pro forma Cr

Assume the participant has a contribution of C(i)=$180 with a BBM of 100×. At the time of claim, Cᵣ=$600,000, Fᵣ=$400,000, and C_{rpf}=$750,000. The cash inflow, Cfia=$650,000 and the cash outflow, Cfoa=$750,000. The AF(T) is computed using k=0.7 as ($600,000+0.7×$400,000+$650,000)/($750,000+0.7×$400,000+$750,000)=0.85955. Correspondingly, the benefit payout would be $180×100×0.85955=$15,471.91.

It should be noted that all other possible variations in computing AF(.) are trivial extensions, and they are assumed covered by this invention.

According to an aspect of this invention, the surplus redistribution to the insured is based on a formula that takes into account the total Cᵣ collected from the contributions of all insured. From time to time, the fund receives profit redistribution from the fund operator. Each insured is a ‘stakeholder’ or ‘equity owner’ of the insurance fund. Therefore, the surplus obtained after collecting all premiums, paying all claims and other operational expenses, and obtaining investment returns from the fund are redistributed to the insured. In one embodiment, the participant is eligible for a share of the surplus only when the policy term lapses and the participant exits the fund. In another embodiment, the participant is eligible for a share of the surplus when the participant cancels the policy and leaves the fund before the term lapses. In yet another embodiment, the participant requests his share of the surplus during the term. Many such variations are covered by the invention.

The total surplus of the fund at say month 3 is determined by subtracting from the earned component of Cᵣ collected from all participants the following:
a. total operational costs of the fund including salaries,
b. all realized claims payout until month 3, and
c. the expected value of total claims payout for the existing participants based on remaining duration, i.e., from months 3 to 12, with a 99% confidence interval.

According to this invention, the formula for the surplus redistribution benefit for a time interval T-T3, by considering the surplus that remains in the fund is as follows:

$$B S ( T 3 , i ) = S f ( T 3 ) \times [ {\sum }_{T}^{T 3} C ( i ) / ( {\sum }_{i} {\sum }_{T}^{T 3} C ( i ) ] \qquad ( 3 )$$

where
BS(T3, i)—the surplus benefit payable to policyholder-(i) at time point T3
Σ_{T}^{T3} C(i)—The total contributions paid by policyholder-(i) from T to T3
Σᵢ Σ_{T}^{T3} C(i)—The total contributions paid by all active policyholders and not paid out from T to T3
Sf (T3)—The total surplus in the fund at T3

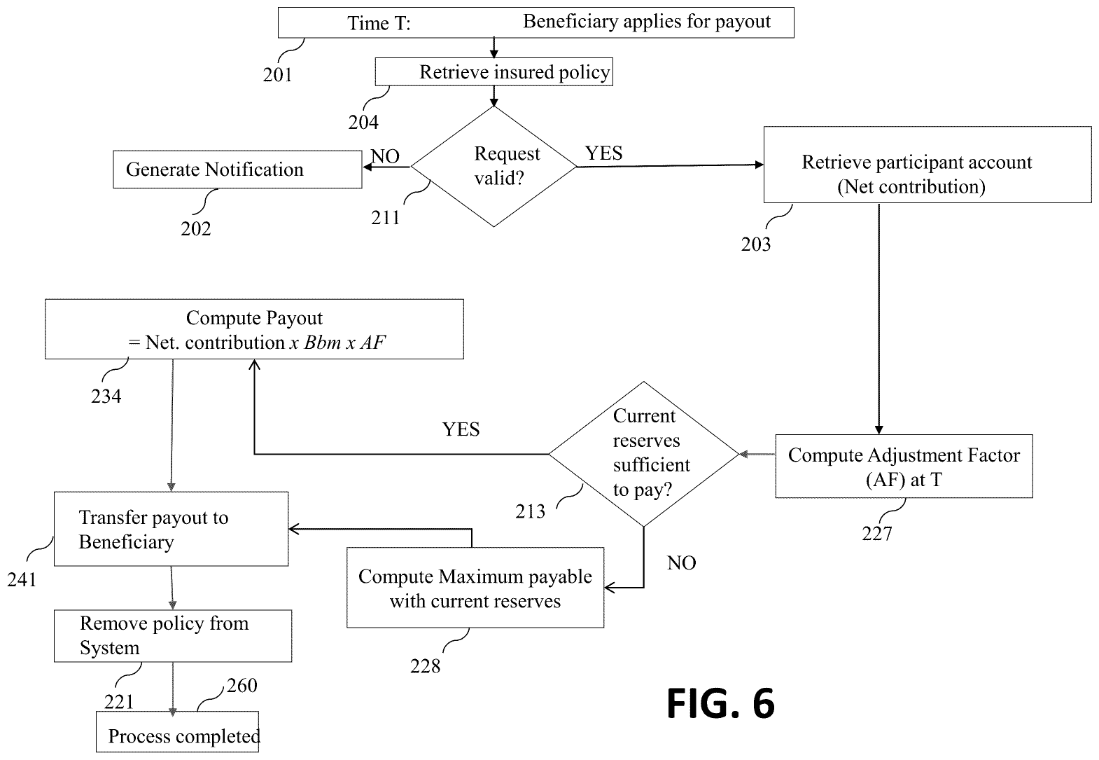

FIG. 6 is a simplified flowchart showing the steps of variable payout calculation according to an aspect of this invention. The process starts at Step 201 at time T when the beneficiary applies for the benefit payment. In Step 204, the system retrieves the membership details of the insured including Bbm. At check point 211, it determines if the beneficiary's request is valid. If not, in Step 202, the system generates a notification to the beneficiary. The request may be denied for various reasons, such as the beneficiary not being declared on the policy or one or more conditions in the policy not being fully met. If the request is valid, in Step 203, the system retrieves the insured's account. The account information contains the net contribution. Next, in step 227, the system calculates AF according to Eq. (2a), (2b) or (2c). Checkpoint 213 determines if actual reserves in the fund are sufficient to pay the claim. If yes, then in step 234, AF and BBM are used as in Eq. (1) to calculate the payout. Otherwise, in Step 228, the claim amount is amended to the maximum amount payable by the fund. In Step 241, the payout is transferred to the beneficiary's account, and the insured's policy is removed from the system in Step 221. In one embodiment, after the payout, an updated AF is computed for future use. A log is created on the system and the process is completed in Step 260. Note that in another embodiment, the system may automatically compute AF at each claim payout, thereby keeping it current, in which case step 227 at the time of payout may not be needed.

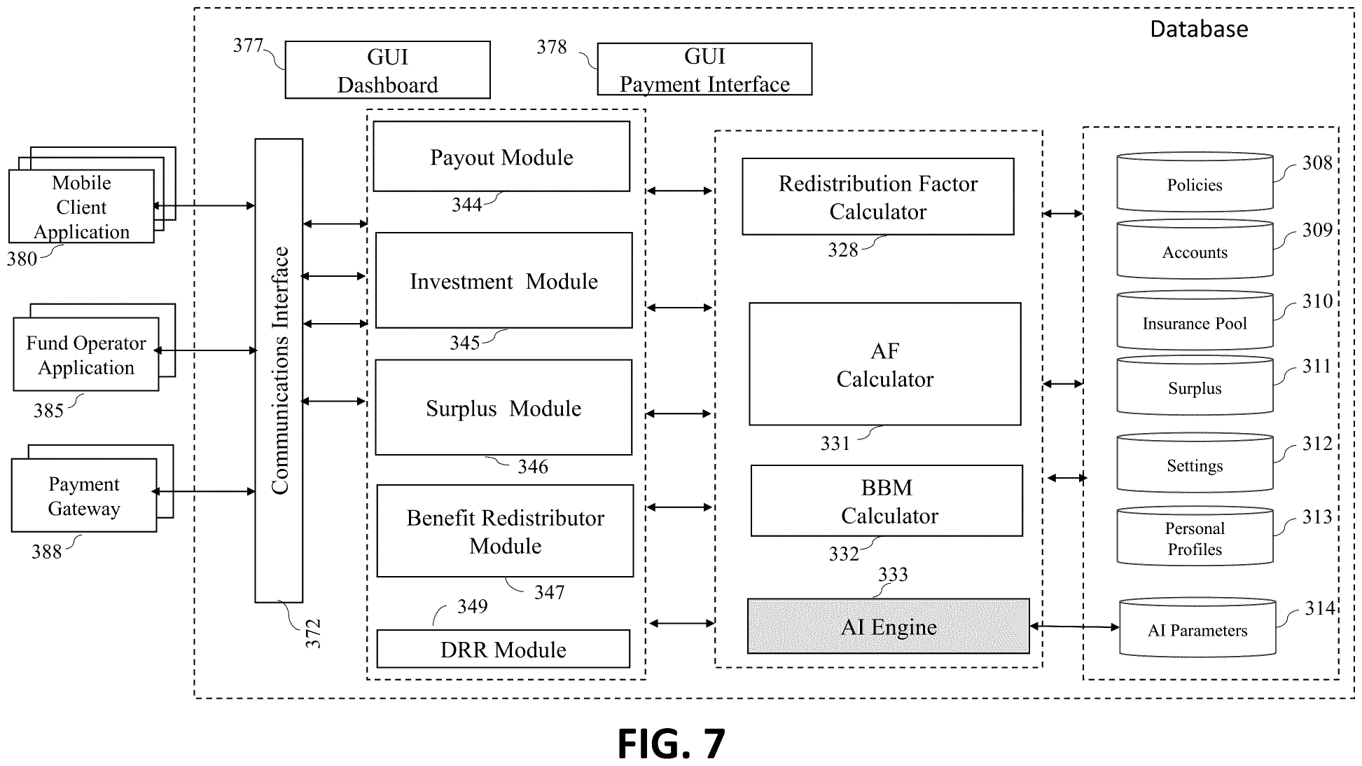

FIG. 7 shows a high-level block diagram as an exemplary embodiment of the system of invention and its external and internal interfaces. The system is comprised of a data store, such as a database that may be centralized or distributed, and a processor that runs one or more software programs. These components are located in a centralized server or in several distributed servers. The data store may be a relational (such as SQL), object-oriented or NoSQL database, all well-known in prior art. Furthermore, the data store may be a Blockchain that stores data in the form of blocks. Database stores all relevant data of the insurance fund such as participant policies 308, participant accounts 309, personal profiles 313, as well as historic and present information on insurance pool 310 (including claims reserve and fund reserve pro forma and current values, and ratios) and surplus 311. It also stores user and system settings 312 that include security information such as user access rights to the system. If the system uses Machine Learning (ML), it also stores the Artificial Intelligence (AI) parameters in 314.

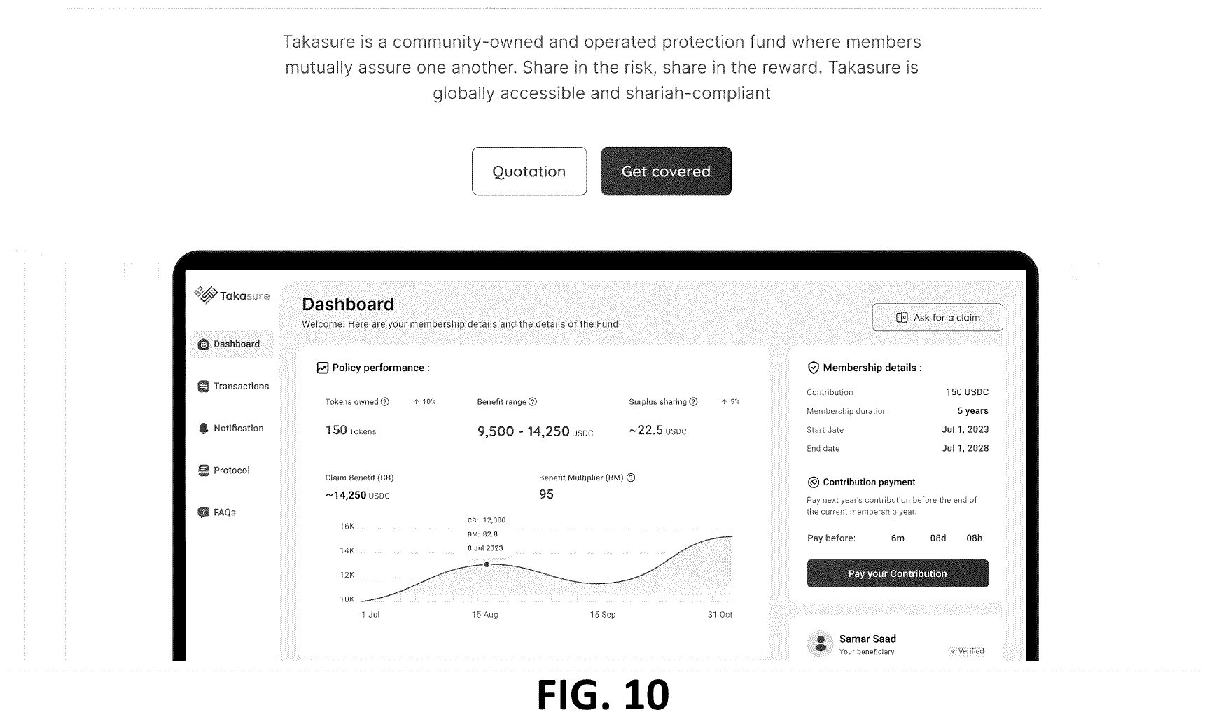

The system has communications interface 372 to connect the fund's server to the public Internet through which the server communicates with remote client participants that may use a web browser on their computer or use a mobile client application 380, Fund Operator 111's client application 385 and Payment Gateway 388. Communication Interface 372 supports Internet Protocol (IP), well known in prior art. Protocols well-known in prior art such as TCP, UDP and HTTP may be used to communicate between server and client applications or between distributed servers of the system. Furthermore, the system has a graphical user interface (GUI) that has Dashboard 377 and Payment Interface 378. The participant reaches Dashboard 377 through user authentication. The participant can view his insurance account status, estimated payout, fund status, and fund parameters. The participant can modify the personal profile parameters. An exemplary dashboard using a web page is illustrated in FIG. 10.

Receiving payments from the participant or paying to the beneficiary requires Payment Interface 378 through which financial transactions can securely be made. The insurance fund may accept the premium payment using a credit card number, a bank account transfer (e.g., EFT), or a cryptocurrency transfer. The fund would have one or more bank accounts and/or credit card accounts wherein financial transactions are handled and the fund's account is stored. For that, Payment Gateway 388 over the Internet is used to connect to the insurance fund's bank account and the insurance fund's credit card account, or the insurance fund's crypto wallet on a blockchain. There may be a plurality of Payment Gateways 388 used depending on various forms of financial transactions allowed. A payment gateway acts as the central payment processing system used on systems that use the public Internet. Within a transaction, it is the front-end mechanism that collects, transfers, and authorizes customer information in real time to a merchant's bank, where the transaction itself is then processed. Through this method, the front-end checkout will occur on the insurance company's web pages but the payment processing happens through the gateway's back end. Through Payment Gateway 388, the insurance fund's Fund Management group can access the fund's account and manage the account just as having the account locally.

The system of invention may be implemented in different configurations. For example, the system may use blockchain, a distributed infrastructure across nations wherein the blockchain is stored in many locations, accept premium payments in the form of cryptocurrency, provide policies in the form of smart contracts, and issue tokens to participants in return for payments wherein participants hold crypto wallets. This arrangement would be useful, especially for the fund to have access to participants in many nations, and avoids the limitations of using local currency and inflation. However, it may be more complex because in addition to technology challenges, the national regulatory laws may limit the operations.

The system of invention has several software modules: Payout Module 344 is used to calculate benefit payment and execute steps required to transfer benefit to beneficiary. Investment Module 345 makes a determination of the amount that can be invested and execute steps required to transfer money to the Fund Operator for investment purposes and receive investment returns. Surplus Module 346 keeps track of the fund's surplus and reports to Investment Module 345 and Benefit Redistributor Module 347 which executes steps required to redistribute the surplus to participant's accounts.

DRR Module 349 periodically checks the use of Cᵣ and Fᵣ, and can tune their relative ratios. When DRR Module 349 detects that Fᵣ falls below a certain threshold compared to its pro forma level, it triggers the calculation of said ratio for all new members and renewing members. DRR Module 349 records the new ratio in the system database.

These modules may be designed as separate software components that interwork on the same server or may be distributed to different servers that interwork with the IP protocol. One or more Application Programming Interfaces (APIs) are defined for the interworking of different software modules of the system.

Various factors used to calculate the variable benefit payment and the surplus redistribution are handled by stand-alone modules such as AF Calculator 331, BBM Calculator 332 and Redistribution Factor Calculator 328. AF Calculator 331 may use one or more of the methodologies described in this invention. These software calculators use various data stored in the database, and called by the higher-level Modules. This separation allows parametric changes in the Calculators without impacting the operations of the higher-level Modules.

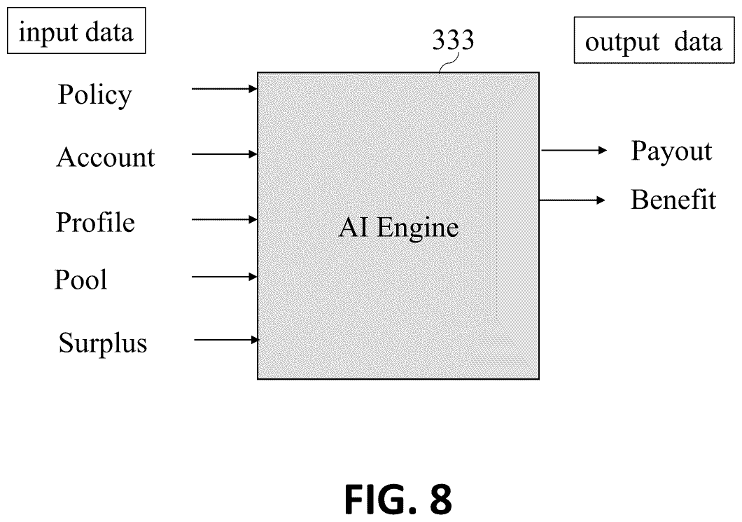

In one embodiment, AI Engine 333 is used in place of all the aforementioned Modules that directly determines the claims benefit, surplus redistribution benefit, DRR and even the optimal investment ratio, as illustrated in FIG. 8. Various types of data are used as input to AI Engine 333, such as participant's policy, personal information, time, fund-related data and parameters such as the amount of reserves, claim payouts, and surplus data. In addition, the fund checks and updates its mortality tables (mortality assumptions) using the AI engine. The fund can use the AI engine to find external data points to gather information to further improve assumptions on the mortality rates of participants through their public activities (such as social media) as well as publicly available information on the locations where they live.

AI Engine 333 is a neural network, such as a deep learning engine well known in prior art, that can solve complex computational problems. There are typically three parts in a multi-layer perceptron-based deep learning neural network: a single input layer, with many nodes attached to the input fields; one or more hidden layers each layer with many nodes; and a single output layer with one or more nodes that attach to output fields. Each layer has a different number of nodes. The total number of nodes, the total number of layers, and the number of nodes per layer are determined according to the chosen AI topology. The nodes across layers are interconnected by varying connection strengths known as weights. Each node essentially multiplies its received input data with certain weights using a linear or nonlinear function and outputs to its next neighbor node.

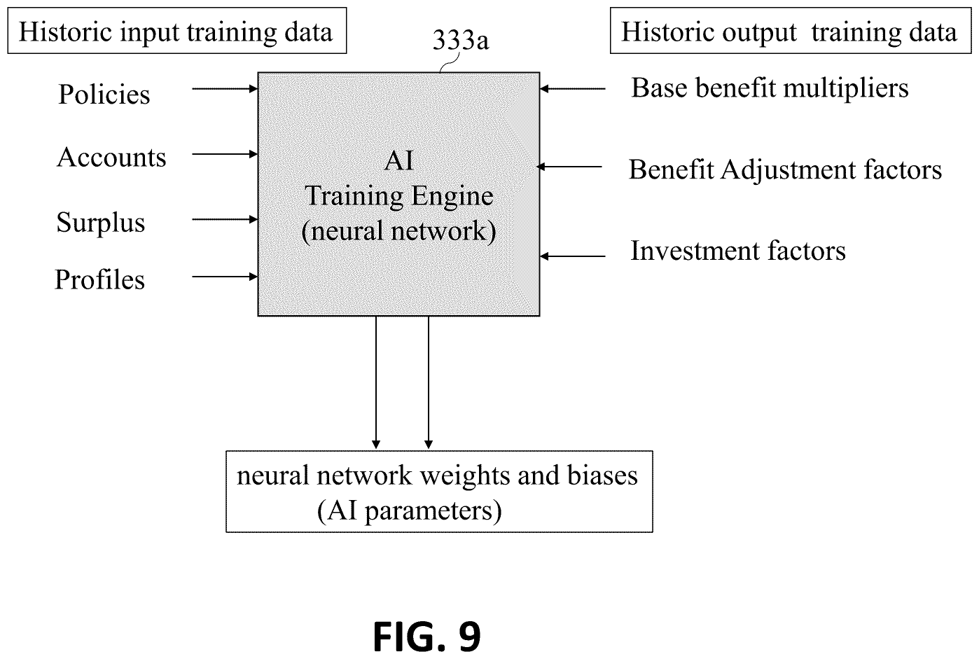

AI Engine 333 can easily be trained using supervised data collected by the insurance fund using AI Engine Trainer 333a according to FIG. 9. The training methods, such as supervised and unsupervised training of an AI engine, are well known in prior art and hence not covered here. AI Engine 333 may be used in tandem with Modules, or as a stand-alone computation engine. When it is used in tandem, the output of the AI engine can be compared with the computation results of the Modules. In the initial phases, the AI engine may be used in tandem. In time, the AI engine may completely replace the Modules.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term ‘software’ is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms ‘computer’, ‘server’, ‘processor’, and ‘memory’ all refer to electronic or other technological devices. These terms exclude people or groups of people. For the purposes of the specification, the terms display or displaying means displaying on an electronic device. As used in this specification and any claims of this application, the terms ‘computer readable medium’ and ‘computer readable media’ are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (‘LAN’) and a wide area network (‘WAN’), an inter-network (e.g., the Internet), and peer-to-peer networks (e.g., ad hoc peer-to-peer networks).

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

### CONCLUSION

A system and method have been shown in the above embodiments for the effective implementation of a method and system for cooperative life insurance with variable payout. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

What is claimed is:

1. An article of manufacture having a non-transitory computer readable storage medium comprising computer readable program code executable by a processor to implement a method of a cooperative life insurance fund with a variable payout, a plurality of participants participating in the cooperative life insurance fund, the non-transitory computer readable storage medium comprising:
(a) computer readable program code receiving a request for participation in a fund for a term from a user, the request comprising a payout and a plurality of information associated with the user;
(b) computer readable program code evaluating the plurality of information associated with the user and verifying an eligibility of the user in the cooperative life insurance fund and, upon verifying eligibility, enrolling the user as a participant among the plurality of participants and generating a policy for the participant for the requested term, wherein the policy specifies a contribution by the participant and a base benefit multiplier, and wherein a payout to a beneficiary of the participant is computed by setting aside a management fee from the contribution by the participant during a time period from a beginning of the term until a time of claim payout, and multiplying a remainder of the contribution by the participant with the base benefit multiplier and a benefit adjustment factor, whereby:
i. the base benefit multiplier is computed using a discrete non-linear function that varies according to one or more information in the plurality of information;
ii. the benefit adjustment factor is computed to be proportional to a difference between a performance of the cooperative life insurance fund at the time of beneficiary payout and a projected fund performance at the beginning of the term;
(c) computer readable program code periodically collecting, over a first pre-determined time interval, a payment for the contribution from the plurality of participants;
(d) computer readable program code periodically computing, over a second pre-determined time interval, the benefit adjustment factor for the cooperative life insurance fund to adjust payouts; and
(e) computer readable program code determining when a payout is deemed necessary to a given beneficiary associated with a given participant among the plurality of participants, and determining a given claim payout and transferring the given claim payout to the given beneficiary and eliminating the given participant among the plurality of participants associated with the cooperative life insurance fund.

2. The article of manufacture as per claim 1, wherein the plurality of information associated with the user comprises any of, or a combination of, the following: age, gender, occupation, location, lifestyle, and health condition of the user.

3. The article of manufacture as per claim 1, wherein the non-transitory computer readable storage medium further comprises:
(a) after setting aside the management fee, for each participant, computer readable program code maintaining a balance in a claims reserve and a fund reserve according to a pre-determined reserve ratio, wherein funds in the claims reserve and fund reserve are used to pay claims, and wherein the fund reserve has strictly unearned premium, and the claims reserve has both unearned and earned premiums;
(b) computer readable program code transferring a portion of fund reserve to a fund operator for investment purposes;
(c) computer readable program code receiving periodically, from the fund operator, investment income;
(d) computer readable program code adding, the investment income to the cooperative life insurance fund;
(e) computer readable program code determining, as a surplus, an earned premium component of the claims reserve remaining after an actual as well as an expected claims are paid out for a time period; and
(f) computer readable program code redistributing a portion of the cooperative life insurance fund as surplus to each participant within the plurality of participants at a term end in form of a cash return proportional to the ratio of total contributions made by each participant to the total contributions collected from the plurality of participants who are not paid out.

4. The article of manufacture of claim 3, wherein the predetermined reserve ratio is dynamically readjusted for all new participants and renewing participants when the cooperative life insurance fund reserve falls below a certain threshold compared to its pro-forma level due to claims payouts.

5. The article of manufacture of claim 1, wherein the benefit adjustment factor is equal to one if the cooperative life insurance fund's actual performance is same as or better than the projected fund performance at the beginning of the policy, and slightly less than one if the cooperative life insurance fund's actual performance is worse than the projected fund performance.

6. The article of manufacture of claim 5, wherein actual and projected performances is determined using any of, or a combination of, the following: a shortfall method, a cashflow method, and a loss ratio method.

7. The article of manufacture of claim 6, wherein the shortfall method is as follows:
$$AF ( T ) = \{ \begin{matrix}1 & ; & P a \leq Pe \\ ( Cr + k \times Fr - ( P a - P e ) ) / ( Cr + k \times Fr ) ) & ; & P a > Pe\end{matrix}$$
where
Pa—total actual claims,
P—total projected claims at underwriting,
(Pa−Pe)—shortfall of total claims,
Cr—current claims reserve,
Fr—current fund reserve, and
k—a scalar determining the portion of Fᵣ used for claim payouts.

8. The article of manufacture of claim 7, wherein the scalar k is 0.7.

9. The article of manufacture of claim 6, wherein the cash flow method is as follows:
$$AF ( T ) = \{ \begin{matrix}\begin{matrix}1 ; & ( Cfia + Cr ) \geq ( Cfoa + Crpf )\end{matrix} \\ \begin{matrix}( Cr + k \times Fr + Cfia ) / ( Crpf + k \times Fr + Cfoa ) ; & oth erwise\end{matrix}\end{matrix}$$
where
Cfia—cash in expected over the next 12 mo. through contributions from renewals and new policies
Cfoa—cash out expected over the next 12 mo. through payments of claims
Crpf—pro-forma Cr
Pa—total actual claims,
Pe—total projected claims at underwriting,
(Pa−Pe)—shortfall of total claims,
Cr—current claims reserve,
Fr—current fund reserve, and
k—a scalar determining the portion of Fr used for claim payouts.

10. The article of manufacture of claim 9, wherein the scalar k is 0.7.

11. The article of manufacture of claim 6, wherein the loss-ratio method is as follows:
$$AF ( T ) = \{ \begin{matrix}1 & ; & LRa \leq LRe \\ 1 - ( L r a - L r e ) & ; & LRa > LRe\end{matrix}$$
where
Lra—current loss ratio at T, and
Lre—loss ratio threshold.

12. The article of manufacture of claim 1, wherein the non-transitory computer readable storage medium further comprises computer readable program code terminating a first participant's policy after an expiration of an associated term, and returning to said first participant, a share of a surplus.

13. The article of manufacture of claim 12, wherein the share of the surplus is computed as follows:
$$BS ( T 3 , i ) = S f ( T 3 ) \times [ {{\sum }^{T 3}}_{T} C ( i ) / {\sum }_{i} {{\sum }^{T 3}}_{T} C ( i ) ]$$
where
BS(T3, i)—the surplus benefit payable to policyholder-(i) at time point T3
Σ_{T}^{T3} C(i)—the total contributions paid by policyholder-(i) from T to T3
Σᵢ Σ_{T}^{T3} C(i)—the total contributions paid by all active policyholders and not paid out from T to T3, and
Sf (T3)—the total surplus in the fund at T3.

14. A system comprising:
(a) a processor;
(b) storage storing computer readable programmable code executable by the processor, the storage comprising:
i. computer readable program code receiving a request for participation in a fund for a term from a user, the request comprising a payout and a plurality of information associated with the user;
ii. computer readable program code evaluating the plurality of information associated with the user and verifying an eligibility of the user in the cooperative life insurance fund and, upon verifying eligibility, enrolling the user as a participant among the plurality of participants and generating a policy for the participant for the requested term, wherein the policy specifies a contribution by the participant and a base benefit multiplier, and wherein a payout to a beneficiary of the participant is computed by setting aside a management fee from the contribution by the participant during a time period from a beginning of the term until a time of claim payout, and multiplying a remainder of the contribution by the participant with the base benefit multiplier and a benefit adjustment factor, whereby: (1) the base benefit multiplier is computed using a discrete non-linear function that varies according to one or more information in the plurality of information; and (2) the benefit adjustment factor is computed to be proportional to a difference between a performance of the cooperative life insurance fund at the time of beneficiary payout and a projected fund performance at the beginning of the term;
iii. computer readable program code periodically collecting, over a first pre-determined time interval, a payment for the contribution from the plurality of participants;
iv. computer readable program code periodically computing, over a second pre-determined time interval, the benefit adjustment factor for the cooperative life insurance fund to adjust payouts; and
v. computer readable program code determining when a payout is deemed necessary to a given beneficiary associated with a given participant among the plurality of participants, and determining a given claim payout and transferring the given claim payout to the given beneficiary and eliminating the given participant among the plurality of participants associated with the cooperative life insurance fund;
(c) a database to store participant profiles, accounts, policies and security settings, and historic and present insurance fund information including pool, surplus and investments; and
(d) a communications interface to communicate with at least a fund operator's system, a participant's client application, and a payment gateway.

15. The system of claim 14, wherein the benefit adjustment factor is equal to one if the cooperative life insurance fund's actual performance is same as or better than the projected fund performance at the beginning of the policy, and slightly less than one if the cooperative life insurance fund's actual performance is worse than the projected fund performance.

16. The system of claim 15, wherein actual and projected performances is determined using any of, or a combination of, the following: a shortfall method, a cashflow method, and a loss ratio method.

17. The system of claim 16, wherein the shortfall method is as follows:
$$AF ( T ) = \{ \begin{matrix}1 & ; & P a \leq Pe \\ ( Cr + k \times Fr - ( P a - P e ) ) / ( Cr + k \times Fr ) ) & ; & P a > Pe\end{matrix}$$
where
Pa—total actual claims,
Pe—total projected claims at underwriting,
(Pa−Pe)—shortfall of total claims,
Cr—current claims reserve,
Fr—current fund reserve, and
k—a scalar determining the portion of Fᵣ used for claim payouts.

18. The system of claim 16, wherein the cash flow method is as follows:
$$AF ( T ) = \{ \begin{matrix}\begin{matrix}1 ; & ( Cfia + Cr ) \geq ( Cfoa + Crpf )\end{matrix} \\ \begin{matrix}( Cr + k \times Fr + Cfia ) / ( Crpf + k \times Fr + Cfoa ) ; & oth erwise\end{matrix}\end{matrix}$$
where
Cfia—cash in expected over the next 12 mo. through contributions from renewals and new policies
Cfoa—cash out expected over the next 12 mo. through payments of claims
Crpf—pro-forma Cr
Pa—total actual claims,
P—total projected claims at underwriting,
(Pa−Pe)—shortfall of total claims,
Cr—current claims reserve,
Fr—current fund reserve, and
k—a scalar determining the portion of Fr used for claim payouts.

19. The system of claim 16, wherein the loss-ratio method is as follows:
$$AF ( T ) = \{ \begin{matrix}1 & ; & LRa \leq LRe \\ 1 - ( L r a - L r e ) & ; & LRa > LRe\end{matrix}$$
where
Lra—current loss ratio at T, and
Lre—loss ratio threshold.

20. The system of claim 14, wherein the non-transitory computer readable storage medium further comprises computer readable program code terminating a first participant's policy after an expiration of an associated term, and returning to said first participant, a share of a surplus, wherein the share of the surplus is computed as follows:
$$BS ( T 3 , i ) = S f ( T 3 ) \times [ {{\sum }^{T 3}}_{T} C ( i ) / {\sum }_{i} {{\sum }^{T 3}}_{T} C ( i ) ]$$
where
BS(T3, i)—the surplus benefit payable to policyholder-(i) at time point T3
Σ_{T}^{T3} C(i)—the total contributions paid by policyholder-(i) from T to T3
Σᵢ Σ_{T}^{T3} C(i)—the total contributions paid by all active policyholders and not paid out from T to T3, and
Sf (T3)—the total surplus in the fund at T3.
